(19) United States
(12) Patent Application Publication
(10) Pub. No.: US 2014/0296122 A1
(43) Pub. Date: Oct. 2, 2014

(54) SANITIZING DISH SOAP

(71) Applicant: Dan Sullivan, (US)

(72) Inventor: Dan Sullivan, Cincinnati, OH (US)

(73) Assignee: Dan Sullivan, Cincinnati, OH (US)

(21) Appl. No.: 13/852,670

(22) Filed: Mar. 28, 2013

(51) Int. Cl. C11D 3/48

(52) U.S. Cl. CPC C11D 3/48
USPC 510/235

(57) ABSTRACT

A detersive agent for washing has been provided. The detersive agent includes four parts of 5% acetic acid and one part of alpha-olefin sulfonate (AOS-40). The detersive agent helps in completely removing the bacterial growth during dishwashing and other uses. The detersive agent is an effective grease cutter, and sudsy, non streaking cleaner and sanitizer.

### BACKGROUND OF THE INVENTION

1. Field of the Invention

The present invention generally relates to a detersive agent for washing, and more particularly relates to dishwashing.

2. Description of Related Art

Next to the toilet trap, dish sponges are the second dirtiest item in the home with 174,000 bacteria per square inch. Many of these bacteria are dangerous such as E. coli and Salmonella. The danger is increasing, as the bacteria have become resistant to antibiotics.

Current methods and means for addressing bacteria are ineffective, studies confirm that “antibacterial” dish soaps leave the sponge infested with bacteria within one day. Even at full strength, solution tests confirm current antibacterial dish soaps are ineffective against micro-organisms such as E. coli.

Therefore, there is need for a detersive agent for washing that destroys bacteria and other organisms completely. Further, the detersive agent is made by combining white vinegar with the primary cleansing ingredient in hand soap, AOS-40, creating a robust natural detersive that is highly effective at killing bacteria, especially in the dish sponge, yet is soft on hands and the environment. Further, the detersive agent should be a significant improvement in dish washing hygiene.

### SUMMARY OF THE INVENTION

In accordance with the teachings of the present invention a detersive agent for washing including four parts of acetic acid and one part of alpha-olefin sulfonate (AOS-40) is provided.

Another object of the present invention is to provide a detersive agent with 5%-acetic acid as white vinegar and AOS-40 including sulfonic acids, sodium chloride, sodium sulfate solution and water.

Another object of the present invention is to provide a detersive agent with AOS-40 which is readily available as surfactant for personal care.

Another object of the present invention is to provide a liquid detergent for dishwashing.

Another object of the present invention is to provide a detergent that employs highly effective bacteria fighting properties while using only two chemicals that are well known for being gentle on skin.

### BRIEF DESCRIPTION OF DRAWINGS

FIG. 1 illustrates a table to indicate the composition of the detergent, in accordance with a preferred embodiment of the present invention; and

FIG. 2 illustrates a table to indicate the composition of the Alpha-Olefin Sulfonate (AOS-40), in accordance with a preferred embodiment of the present invention.

### DETAILED DESCRIPTION OF DRAWINGS

While this technology is illustrated and described in a preferred embodiment, the detersive agent may be produced by many different processes, configurations and forms. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

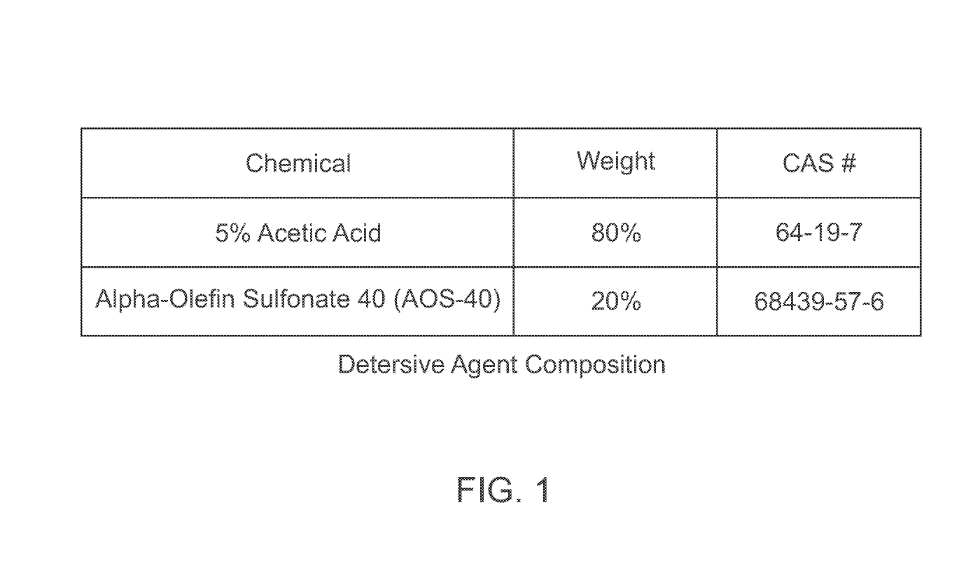

FIG. 1 illustrates a table for determining the composition of the detersive agent in accordance with a preferred embodiment of the present invention. The detersive agent for washing includes four parts of 5% acetic acid and one part of alpha-olefin sulfonate (AOS-40). Herein four parts refer to 80% and one part refers to 20% in accordance to the preferred embodiment of the present invention. The four parts of 5% acetic acid and one part of the AOS-40 are mixed gently at room temperature. Further, in another embodiment of the present invention, bubbles formation is to be avoided while mixing the detersive agent. The CAS number for the acetic acid is 64-19-7 and for the alpha-olefin sulfonate (AOS-40) is 68439-57-6.

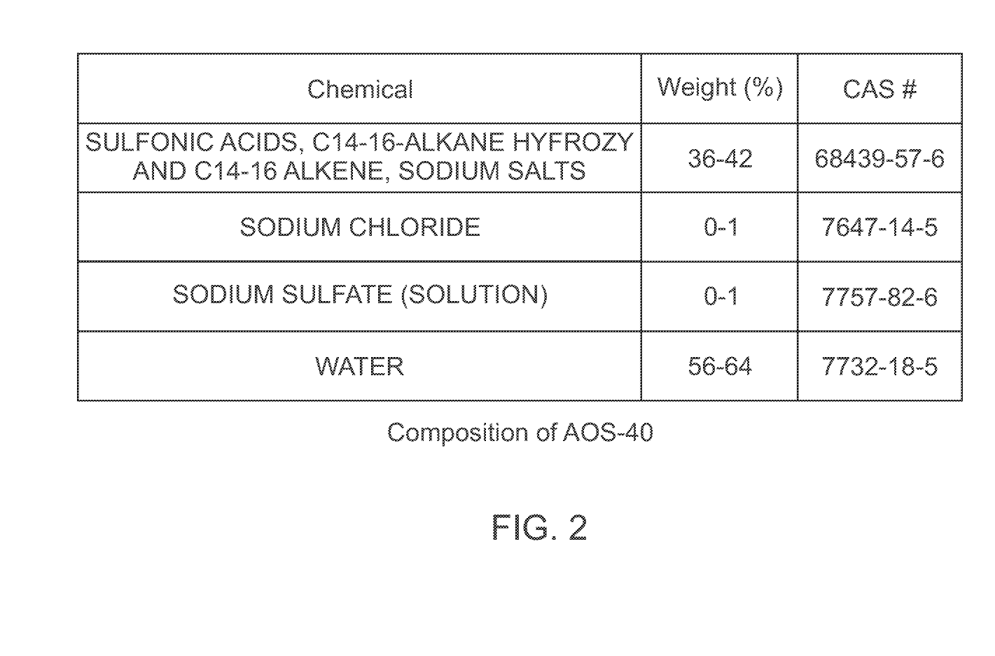

FIG. 2 illustrates a table for determining the composition of alpha-olefin sulfonate 40 (AOS-40), in accordance with a preferred embodiment of the present invention. The alpha-olefin sulfonate (AOS-40) includes sulfonic acids, C14-16-alkane hyfrozy AND C14-16 alkene, sodium salts (Cas#68439-57-6 and weight 36-42%); sodium chloride (Cas#7647-14-5 and weight 0-1%); sodium sulfate solution (Cas#7757-82-6 and weight 0-1%); and water (Cas#7732-18-5 and weight 56-64%). The alpha-olefin sulfonate 40 (AOS-40) is surfactant used for personal care. The alpha-olefin sulfonate 40 (AOS-40) is readily available in the industry. In a preferred embodiment, the alpha-olefin sulfonate 40 from the Jeen International Corporation is used and more preferably JEENATE AOS-40 is used for developing the detersive agent.

In another embodiment of the present invention, the 5% acetic acid is also known as white vinegar. The white vinegar is generally preferred for cooking or table uses. The white vinegar is readily available in the industry. In a preferred embodiment the white vinegar produced by H.J. Heinz Company is used for preparing the detersive agent. In another preferred embodiment of the present invention, vinegars such as rice vinegar, apple vinegar may also be used, without deviating from the scope of the present invention.

### Quality Tests

Following quality tests are performed in different phases to investigate the effectiveness of the detersive agent in eradicating/preventing/reducing harmful bacteria in sponges, sink or washing areas. The test was conducted on following samples:
A. Dawn Dish Soap
B. Palmolive Antibacterial Dish Soap
C. Prime Dish Soap—(Detersive Agent—Claimed product in the present invention)
D. Palmolive Fresh Sponge Dish Soap

PHASE 1: Determination of optimum contact time of the detersive agent for maximum kill rate using E. coli.

SUSPENSION TEST: The 4 different liquid detersive agents A, B, C and D were tested for antimicrobial property following suspension test (EN 1276 Quantitative Suspension for Microbial Activity). The liquid detersive agents were allowed to be in contact with a known amount of bacterial suspension for 5, 15 and 30 minutes with sterile water used as blank. “Prime Dish Soap” is the detersive agent from present invention.

EXPERIMENTAL SET UP: A 24 hour fresh culture was prepared to ensure the quality of the bacterial suspension to be used. The cultures were incubated in a biological incubator at 30° C. The next day a fresh suspension was prepared using sterile nutrient broth and the optical density of the suspension was measured using a spectrophotometer. The liquid detersive agent (9 ml) was taken and mixed with 1 ml of bacterial suspension. After 5 minutes contact time, a 1 ml aliquot was taken into a sterile bottle and subjected to serial dilution using sterile water. From each dilution, 1 ml was taken onto a plated petri plates and this was incubated for 24 hours in a biological incubator at 30° C. Then the colonies were counted by taking pictures using a computerized plate counter.

### RESULT AND CONCLUSION

For presentation of the data, the average value colony forming unit (cfu/ml) of E. coli are used and termed as microbes (Table 1). It is clear from the data below that solution C is the most efficient, followed by solution B. Data shows that solution C completely eradicates the bacterial growth at all the 3 contact times. Result below is an average value of 3 replicates of the same treatment to have reproducibility of the test.

TABLE 1
Microbial count on treated and blank plates at 5 minutes
(cfu/ml)

| Treatments | Untreated Control | | | | |
|---|---|---|---|---|---|
| Dilution | Deionized Water | A | B | C | D |
| 10⁻¹ | 2.1 × 10⁻⁸ | 3.3 × 10⁻³ | 5.0 × 10⁻³ | 0 | TC* |
| 10⁻² | 2.8 × 10⁻⁷ | 2.3 × 10⁻² | 1.0 × 10⁻³ | 0 | 2.6 × 10⁻⁸ |
| 10⁻³ | 3.9 × 10⁻⁶ | 2.2 × 10⁻² | 0 | 0 | 1.5 × 10⁻⁷ |
| 10⁻⁴ | 5.3 × 10⁻⁵ | 1.9 × 10⁻² | 0 | 0 | 7.2 × 10⁻⁶ |
| 10⁻⁵ | 7.0 × 10⁻⁴ | 6.9 × 10⁻¹ | 0 | 0 | 1.6 × 10⁻⁶ |

*TC = Too many to count

The data collected after 15 and 30 minutes contact again showed that solution D has 100% kill rate. Compared with the control, all the other solutions also showed significant kill rate after 15 minutes at the lower dilutions.

TABLE 2
Microbial count on treated and blank plates at 15 minutes
(cfu/ml)

| Treatments | | | | | |
|---|---|---|---|---|---|
| Dilution | Untreated Control | A | B | C | D |
| 10⁻¹ | 2.1 × 10⁻⁸ | 4.3 × 10⁻³ | 4.5 × 10⁻⁵ | 0 | 2.5 × 10⁻³ |
| 10⁻² | 2.8 × 10⁻⁷ | 1.1 × 10⁻² | 5.7 × 10⁻⁴ | 0 | 3.3 × 10⁻⁴ |
| 10⁻³ | 3.9 × 10⁻⁶ | 6.0 × 10⁻² | 1.3 × 10⁻⁴ | 0 | 1.9 × 10⁻⁴ |
| 10⁻⁴ | 5.3 × 10⁻⁵ | 1.0 × 10⁻² | 1.1 × 10⁻⁵ | 0 | 9.2 × 10⁻⁵ |
| 10⁻⁵ | 7.0 × 10⁻⁴ | 3.0 × 10⁻¹ | 7.6 × 10⁻³ | 0 | 2.0 × 10⁻⁶ |

TABLE 3
Microbial count on treated and blank plates at 30 minutes
(cfu/ml)

| Treatments | | | | | |
|---|---|---|---|---|---|
| Dilution | Untreated Control | A | B | C | D |
| 10⁻¹ | 2.1 × 10⁻⁸ | 1.9 × 10⁻⁵ | 1.0 × 10⁻⁶ | 0 | 1.9 × 10⁻⁷ |
| 10⁻² | 2.8 × 10⁻⁷ | 1.0 × 10⁻² | 2.0 × 10⁻⁶ | 0 | 8.8 × 10⁻⁶ |
| 10⁻³ | 3.9 × 10⁻⁶ | 3.0 × 10⁻² | 1.0 × 10⁻⁵ | 0 | 1.5 × 10⁻⁶ |
| 10⁻⁴ | 5.3 × 10⁻⁵ | 1.1 × 10⁻² | 2.0 × 10⁻⁴ | 0 | 2.8 × 10⁻⁵ |
| 10⁻⁵ | 7.0 × 10⁻⁴ | 1.8 × 10⁻¹ | 3.0 × 10⁻³ | 0 | 2.0 × 10⁻⁵ |

Conclusion: It can be concluded from the above data collected that solution C is highly effective at 5, 15 or 30 minutes. Solutions A, B, C and D all showed a higher kill rate with longer duration of contact time compared with shorter duration of 5 minutes. This is probably due to the nature of the chemicals present in the solutions. The effectiveness of each solution over time will be compared and a graph will be produced for the final report. Even though solution C was highly effective at killing bacteria compared with the rest of the other solutions, it would seem necessary to perform a further practical test to simulate real time use, which will be confirmed with the Phase 2 test.

Phase 2: Testing the efficacy of the liquid detersive agent samples to remove grease and bacteria and inhibit further bacterial growth over time.

LABORATORY TEST: Supermarket grade lard was melted and 10 ml of this melted lard was applied to a clean plate and left for 10 minutes under laboratory condition. Then 1 teaspoon of the liquid detersive agent (Untreated Control and A, B, C, and D) was applied to 4 sterile sponges and each used to wash the solidified lard on the plates. After washing, sponges were rinsed and gently squeezed to remove excess water. The sponges are left overnight in a 30° C. incubator, to encourage bacterial growth. A control sponge was used to clean the lard without soap and incubated in order to find out the base microbial growth on untreated sponges. Prints of the sponges were taken the next day on an agar plate and incubated for 24 hours at 30° C. and microbial count was performed using a computerized plate counter. This was performed for all the sponges and all the liquid detersive agent samples and the results are presented in the table below.

TABLE 4
Microbial count sponges used for washing dirty plates
(cfu/ml)

| Treatments | | | | | |
|---|---|---|---|---|---|
| Dilution | Untreated Control | A | B | C | D |
| 10⁻¹ | 3.1 × 10⁻⁸ | 7.8 × 10⁻³ | 4.7 × 10⁻² | 0 | 3.1 × 10⁻⁴ |
| 10⁻² | 4.5 × 10⁻⁷ | 5.9 × 10⁻² | 8.3 × 10⁻¹ | 0 | 6.6 × 10⁻³ |
| 10⁻³ | 2.6 × 10⁻⁷ | 5.2 × 10⁻² | 4.9 × 10⁻¹ | 0 | 8.3 × 10⁻² |
| 10⁻⁴ | 3.1 × 10⁻⁶ | 7.5 × 10⁻¹ | 9.6 × 10⁻⁰ | 0 | 5.4 × 10⁻² |
| 10⁻⁵ | 8.6 × 10⁻⁴ | 2.9 × 10⁻⁰ | 5.4 × 10⁻⁰ | 0 | 7.1 × 10⁻¹ |

### Discussion:

The result clearly showed that there is a significant decrease in microbial growth (cfu/ml) on the sponges cleaned with liquid C, indicating the detersive agent's general antimicrobial property.

### CONCLUSION

Taking the results from phase 1 and 2, it is clear that liquid C is superior to all the other liquid soap samples provided. Phase 1 result showed that the kill rate of liquid C is 100%. Phase 2 result confirmed that dirty sponges washed with liquid C inhibit further growth of bacteria on used sponges.

The present invention offers various advantages such as effectively preventing bacteria from growing. The surfactant and the acetic acid create a robust sanitizer, yet are gentle on hands and the environment. Blending 80% white vinegar and 20% surfactant together creates a wonderfully effective grease cutter, and sudsy, non streaking cleanser and sanitizer.

The foregoing discussions provide the preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

1. A detersive agent comprising:
four parts of acetic acid, wherein said acetic acid is 5% by weight; and
one part of alpha-olefin-sulfonate (AOS-40) mixed with said 5% acetic acid at a room temperature.

2. The detersive agent according to claim 1, wherein one part of alpha-olefin-suffocate (AOS-40) further comprising:
from about 36-42% by weight of sulfonic acids, C14-16-alkane hyfrozy AND C14-16 alkene, sodium salts;
from about 0-1% by weight of sodium chloride;
from about 0-1% by weight of sodium sulfate solution; and
from about 56-64% by weight of water,

3. The detersive agent according to claim 1 wherein said 5% acetic acid is either apple vinegar or white vinegar or rice vinegar.

4. The detersive agent according to claim 1 wherein said alpha-olefin-sulfonate (AOS-40) is a surfactant for personal care.

5. The detersive agent according to claim 1 is used for dishwashing.

6. A detersive agent comprising:
four parts of acetic acid, wherein said acetic acid is 5% by weight; and
one part of alpha-olefin-sulfonate (AOS-40) mixed with said 5% acetic acid at a room temperature, said alpha-olefin sulfonate (AOS-40) comprising:
from about 36-42% by weight of sulfonic acids, C14-16-alkane hyfrozy AND C14-16 alkene, sodium salts;
from about 0-1% by weight of sodium chloride;
from about 0-1% by weight of sodium sulfate solution; and
from about 56-84% by weight of water.

7. The detersive agent according to claim 6 wherein said 5% acetic acid is either apple vinegar or rice vinegar or white vinegar.

8. The detersive agent according to claim 6 wherein said alpha-olefin-sulfonate (AOS-40) is a surfactant for personal care.

9. The detersive agent according to claim 6 is used for dishwashing.
